(19) United States
(12) Patent Application Publication
(10) Pub. No.: US 2026/0127353 A1
(43) Pub. Date: May 7, 2026

(54) SYSTEM AND METHOD FOR RAPID END-TO-END DIGITAL COMMUNICATION BETWEEN USERS

(71) Applicant: Cognizant Technology Solutions India Pvt. Ltd., Chennai (IN)

(72) Inventors: S T SAILAJA, Chennai (IN); Santanu GOSWAMI, West Bengal (IN); Shrinidhi ARUNAGIRIRAJ, Madurai (IN)

(21) Appl. No.: 19/011,848

(22) Filed: Jan. 7, 2025

(30) Foreign Application Priority Data
Nov. 7, 2024 (IN) 202441085591

(51) Int. Cl. G06F 40/103; G06F 40/40; G06Q 30/018; G06Q 30/0601

(52) U.S. Cl. CPC G06F 40/103; G06Q 30/0185; G06Q 30/0631; G06F 40/40

(57) ABSTRACT

A system and method for rapid end-to-end digital communication between users is provided. An input is received by first user for invoking Graphical User Interface (GUI) on input device for rendering digital communication application subsequent to receiving data related to second user requirements associated with a service. Second user data provided over audio and video communication carried out between first user and second user using audio and video features associated with digital communication application is captured. Product and service specific data associated with second user is extracted based on captured second user data from external data source. Different types of recommendations are provided to first user with respect to product and service specific data associated with second user by implementing different types of conversational AI bots. Parameters associated with product and service specific data are selected. Actionable outcome of digital communication is generated for transmission to input device.

This application claims the benefit of Indian Patent Application No. 202441085591, filed Nov. 7, 2024, which is incorporated by reference in its entirety.

### FIELD

The present invention relates generally to the field of digital communications. More particularly, the present invention relates to rapid end-to-end digital communication between users.

### BACKGROUND

Nowadays, digital communication between people (users) has become quite prevalent. Various organizations around the world have leveraged the benefits of digital communications platforms by implementing multiple tools and techniques for adopting virtual communication options to achieve efficiency and save time. For example, in insurance sector, insurance agents may offer an insurance policy to a consumer using a digital communication interface over a video call or conference/phone call. However, existing digital interface options do not provide a personalized experience during interactions between the users and have complicated interface which provides bulky video calls or conference/phone calls.

Further, existing digital communication platforms utilize legacy technologies and cumbersome techniques to provide digital interactions between users, which are inefficient to operate. Existing digital communication platforms may use complex server configurations and codes which are difficult to develop and maintain. Further, the existing digital communication platforms are inefficient and less engaging, which decreases productivity and increases operational costs. Also, existing digital communication platforms do not provide an interactive display for data rendering and visualization (e.g., graphs, charts, etc.). Further, the existing digital communication platforms do not effectively integrate with next generation tools, thereby providing decreased automation capabilities. Furthermore, existing digital communication platforms do not process data efficiently in real-time, are not able to determine relevance of data appropriately, and do not populate the electronic data transparently. Yet further, typically existing digital communication platforms provide data capture by way of electronic form filing, which is a tedious and a time-consuming process.

In light of the aforementioned drawbacks, there is a need for a system and a method which provides for improving end-to-end digital communication between users. There is a need for a system and a method which provides for rapid end-to-end digital communication between users. There is a need for a system and a method which provides a digital communication platform that processes data efficiently in real-time, is able to determine relevance of data appropriately, and populate the electronic data transparently. Further, there is a need for a system and a method which provides a digital communication platform that increases work productivity and reduces operational costs.

### SUMMARY

In view of various embodiments of the present invention, a system for rapid end-to-end digital communication between users is provided. The system comprises a memory storing program instructions, a processor executing program instructions stored in the memory and a digital communication engine executed by the processor. The digital communication engine is configured to receive an input by a first user for invoking a Graphical User Interface (GUI) on an input device for rendering a digital communication application subsequent to receiving data related to one or more second user requirements associated with a service. The digital communication engine is configured to capture a second user data provided over audio and video communication carried out between the first user and the second using audio and video features associated with the digital communication application. The second user data is captured in one or more digital formats. The digital communication engine is configured to extract product and service specific data associated with the second user based on the captured second user data from an external data source. Further, the digital communication engine is configured to provide one or more types of recommendations to the first user with respect to the product and service specific data associated with the second user by implementing one or more types of conversational AI bots. Further, the digital communication engine is configured to select one or more parameters associated with the product and service specific. Lastly, the digital communication engine is configured to generate an actionable outcome of the digital communication for transmission to the input device.

In various embodiments of the present invention, a method for rapid end-to-end digital communication between users is provided. The method is implemented by a processor executing instructions stored in a memory. The method comprises receiving an input by a first user for invoking a Graphical User Interface (GUI) on an input device (110) for rendering a digital communication application subsequent to receiving data related to one or more second user requirements associated with a service. The method comprises capturing a second user data provided over audio and video communication carried out between the first user and the second user using audio and video features associated with the digital communication application. The second user data is captured in one or more digital formats. Further, the method comprises extracting product and service specific data associated with the second user based on the captured second user data from an external data source. Further, the method comprises providing one or more types of recommendations to the first user with respect to the product and service specific data associated with the second user by implementing one or more types of conversational AI bots. Further, the method comprises selecting one or more parameters associated with the product and service specific data. Lastly, the method comprises generating an actionable outcome of the digital communication for transmission to the input device.

In various embodiments of the present invention, a computer program product is provided. The computer program product comprises a non-transitory computer-readable medium having computer program code stored thereon, the computer-readable program code comprising instructions that, when executed by a processor, causes the processor to receive an input by a first user for invoking a Graphical User Interface (GUI) on an input device for rendering a digital communication application subsequent to receiving data related to one or more second user requirements associated with a service. A second user data provided over audio and video communication carried out between the first user and the second user using audio and video features associated with the digital communication application is captured. The second user data is captured in one or more digital formats. Further, product and service specific data associated with the second user is extracted based on the captured second user data from an external data source. Further, one or more types of recommendations are provided to the first user with respect to the product and service specific data associated with the second user by implementing one or more types of conversational AI bots. Further, one or more parameters associated with the product and service specific data are selected. Lastly, an actionable outcome of the digital communication is generated for transmission to the input device.

### BRIEF DESCRIPTION OF THE ACCOMPANYING DRAWINGS

The present invention is described by way of embodiments illustrated in the accompanying drawings wherein:

FIG. 1 is a block diagram of a system for rapid end-to-end digital communication between users, in accordance with an embodiment of the present invention;

FIGS. 2 and 2A illustrate a flowchart depicting a method for rapid end-to-end digital communication between users, in accordance with an embodiment of the present invention; and FIG. 3 illustrates an exemplary computer system in which various embodiments of the present invention may be implemented.

### DETAILED DESCRIPTION

The present invention discloses a system and a method which provides for rapid end-to-end digital communication between users. The present invention facilitates completion of end-to-end tasks with a single click. The present invention provides for an improved digital communication platform that provides personalized experience during interactions between users. Further, the present invention provides for a digital communication platform with an interface for digital audio and video communication. Also, the present invention discloses a system and a method which provides for efficient digital communication by using low-code and serverless technologies for easily rendering and maintaining digital communication application. Yet further, the present invention discloses a system and a method which provides for interactive display for data rendering and visualization via the digital communication platform. Further, the present invention discloses a system and a method which provides for the digital communication platform which effectively integrates with next generation tools and provides increased automation capabilities. Furthermore, the present invention discloses a system and a method which provides for a digital communication platform that processes data efficiently in real-time, is able to determine relevance of data appropriately, and populates the electronic data transparently. Furthermore, the present invention discloses a system and a method which provides for automatic data capture using digital audio/video techniques. Yet further, the present invention discloses a system and a method which provides for a digital communication platform that increases work productivity and reduces operational costs.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

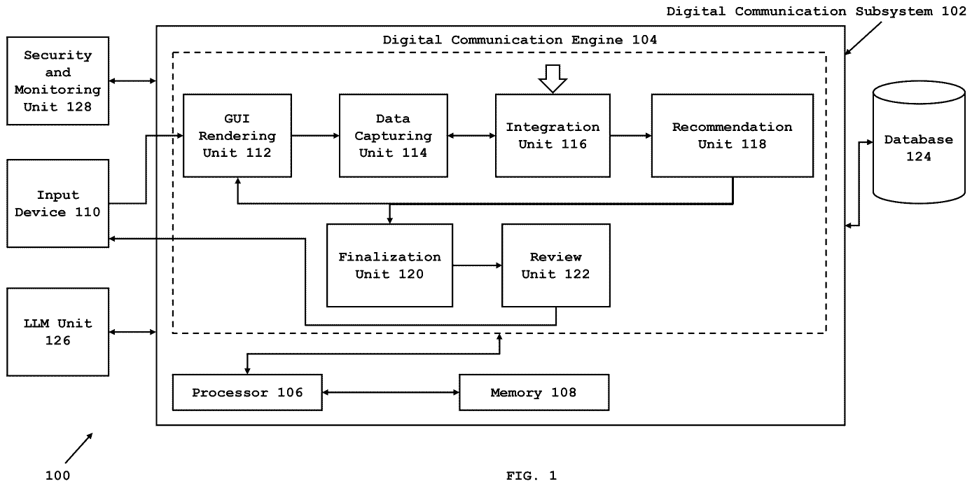

FIG. 1 is a detailed block diagram of a system 100 for rapid end-to-end digital communication between users, in accordance with various embodiments of the present invention. Referring to FIG. 1, in an embodiment of the present invention, the system 100 comprises a digital communication subsystem 102, an input device 110, a database 124, a Large Language Model (LLM) unit 126, and a security and monitoring unit 128. In an exemplary embodiment of the present invention, the input device 110 is an electronic device associated with a user such as, but is not limited to, a smartphone, a mobile phone, a computer and a laptop. In an embodiment of the present invention, the LLM unit 126 employs Gen AI techniques (operating on Large Language Model (LLM) (e.g., GPT4®), which consumes user inputs as a query or a prompt to provide a desired output. The input device 110, the database 124, the LLM unit 126, and the security and monitoring unit 128 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN).

In an embodiment of the present invention, the subsystem 102 is configured to facilitate digital communication between users by employing a low-code and a serverless cloud-based architecture. The subsystem 102 is configured to implement and combine advanced tools and cognitive intelligence techniques such as, artificial intelligence (AI), machine learning (ML), conversational AI bots and Generative Artificial Intelligence (Gen AI) techniques for providing improved digital communication. The subsystem 102 is configured to integrate with multiple external databases for providing seamless data integration for usage in digital communications. Further, the subsystem 102 is configured to use a reflexive workflow and a case management technique (e.g., techniques for assigning and managing user requests) for providing improved digital communications. Further, the subsystem 102 is configured to provide an interactive Graphical User Interface (GUI) for rendering and visualizing captured data, recommendations with respect to user needs and requirements, and digital operations. The sub-system 102 is a digital platform that facilitates rapid end-to-end completion of tasks via a single click of a Uniform Resource Locator (URL).

In an embodiment of the present invention, the subsystem 102 comprises a digital communication engine 104 (engine 104), a processor 106, and a memory 108. In various embodiments of the present invention, the engine 104 has multiple units which work in conjunction with each other for carrying out digital communication between users. The various units of the engine 104 are operated via the processor 106 specifically programmed to execute instructions stored in the memory 108 for executing respective functionalities of the units of the engine 104 in accordance with various embodiments of the present invention.

In another embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to a user as Software as a Service (SaaS) over a communication network.

In another embodiment of the present invention, the subsystem 102 may be implemented as a client-server architecture or in an application-based environment. In this embodiment of the present invention, a client terminal accesses a server hosting the subsystem 102 over a communication network. The client terminals may include but are not limited to a smart phone, a computer, a tablet, microcomputer or any other wired or wireless terminal. The server may be a centralized or a decentralized server.

In an embodiment of the present invention, the engine 104 comprises a Graphical User Interface (GUI) rendering unit 112, a data capturing unit 114, an integration unit 116, a recommendation unit 118, a finalization unit 120 and a review unit 122.

In operation, in an embodiment of the present invention, the integration unit 116 is configured to integrate with a relationship management tool (not shown) (e.g., Salesforce Customer Relationship Management (CRM) tool), for receiving data relating to one or more second user requirements associated with a service provided by an organization relating to a particular domain. The received data may be accessed by a first user of the subsystem 102. The first user is a representative or employee of an organization relating to a particular domain. For example, the first user may be an insurance agent in an insurance company. In an embodiment of the present invention, the Graphical User Interface (GUI) rendering unit 112 is configured to invoke a GUI on the input device 110 for rendering the digital communication application in response to an input provided by a first user over the GUI. The input is received by the GUI rendering unit 112 from the input device 110. In an embodiment of the present invention, the digital communication application is developed in a no-code or low-code manner by using a no-code/low code development platform-as-a-service (e.g., Unqork®) and provides audio and video features along with other features for communication.

In an exemplary embodiment of the present invention, the digital communication application is developed using a ‘React Framework’ which is used to build audio-video component by using an Amazon Web Services (AWS) Chime® Software Development Kit (SDK) and the audio-video component is embedded in the no-code development platform-as-a-service. In an embodiment of the present invention, AWS Chime SDK associated with AWS Chime API is developed for rendering the digital communication application. The first user selects a Universal Resource Locator (URL) link on the input device 110 and inserts login credentials for invoking the GUI for connecting to the digital communication application and provides the inputs. In an exemplary embodiment of the present invention, the URL is a public-facing URL. The input is in the form of a request which represents the first user's requirement for rendering the digital communication application for communicating with the second user. The second user represents one or more users whose requirement data was received via the integration unit 116. The selection of URL renders audio and video chat features on the GUI for allowing the first user to communicate with the second user. The second user is an individual or a customer interested in one or more services provided by the organization in which the first user is employed. For example, the second user may require an insurance policy from the first user. In an embodiment of the present invention, the LLM unit 126 is configured to generate and send a personalised communication (e.g., an email) invite to the second user, prior to the digital communication, relating to the product and service information for the products and services required or availed by the second user. The personalized communication is generated by the LLM unit 126 based on queries constructed from the data related to the second user requirements (e.g., name, age, product, and service details, etc.) which are provided to LLM models in the LLM unit 126 as input for generating the personalized communication. The second user may view the communication invite via an electronic device (e.g., a smartphone, a laptop, a computer, a tablet, etc.) at his/her end.

In an embodiment of the present invention, a pre-determined Domain Name System (DNS) service (e.g., Amazon Route 53®) is implemented by the GUI rendering unit 112 to route the first user input to a content delivery service platform (e.g., Amazon CloudFront®) for rendering the digital communication application on the input device 110. The first user input is routed to the content delivery service platform via an Application Programing Interface (API) gateway (e.g., Amazon API Gateway®). The Application Programing Interface (API) gateway creates and deploys APIs that access the digital communication application implemented using a serverless platform (e.g., Amazon Web Services® (AWS)). The digital communication application is containerized and managed in an application management platform (e.g., Amazon Elastic Kubernetes Service® (Amazon EKS) cluster). One or more audio and video features associated with the digital communication application are built using a Software Development Kit (SDK) (e.g., Amazon Chime SDK®, React, etc.). The audio and video features associated with the digital communication application allow the second user to view the first user and talk to the first user. The digital communication application is deployed in a pre-defined object storage location (e.g., Amazon Simple Storage Service® (Amazon S3) and CloudFront®). In an exemplary embodiment of the present invention, a private connectivity protocol (e.g., AWS Private Link®) is used to keep the network traffic between one or more Virtual Private Clouds (VPCs) associated with the digital communication application development platform and the second user within an AWS network, without using public internet protocols (IPs) and without requiring traffic to traverse across the internet.

In an embodiment of the present invention, the input device 110 fetches the digital communication application from the object storage location when the URL is selected by the first user. The first user communicates and interacts with the second user using the digital communication application. In an embodiment of the present invention, the LLM unit 126 generates and provides a dialogue script by using previously generated risk profile, which are provided as inputs in the form of prompts to the LLM unit 126. The dialogue script is used by the first user for providing product and services recommendations and chat inputs to the second user regarding the product and services. In another embodiment of the present invention, the LLM unit 126 transcribes the audio and video communication between the first user and the second user which is used to determine sentiments (e.g., happy, sad, angry, inquisitive, confused, etc.) of the second user at a particular point in time. The sentiments of the second user are determined by the LLM unit 126 based on one or more phrases provided by the second user during the audio and video communication. In an exemplary embodiment of the present invention, the sentiments are expressed via the GUI by using one or more emojis, which are visible to the first user.

In an embodiment of the present invention, the data capturing unit 114 is configured to automatically capture the second user data from the GUI rendering unit 112. The data capturing unit 114 automatically captures the second user's data provided over the audio and video communication in one or more digital formats associated with the product and service associated with the second user. The second user data may include, but is not limited to, second user personal data (e.g., name, mailing address, email, occupation, mobile number, height, weight, BMI, and social security number, etc.), service details, product details, etc. The data capturing unit 114 implements pre-trained artificial intelligence (AI) techniques (e.g., AWS® transcribe and AWS® comprehend) for automatically capturing the second user data. The automatic capturing of data reduces manual insertion of the second user data and improves quality of capturing data.

In an embodiment of the present invention, the audio and video communication between the first user and the second user is recorded by the data capturing unit 114. In an embodiment of the present invention, the audio and video communication recordings are stored in a storage location such as Amazon S3® buckets and the stored communication recordings are secured using an S3 server-side encryption. In an embodiment of the present invention, the data capturing unit 114 implements an Automated Speech Recognition (ASR) technique (e.g., Amazon Transcribe®) for converting the captured audio and video communication, which are in speech format, into a text format. The implementation of ASR technique aids in automatically populating the second user personal data with a single mouse click. In an exemplary embodiment of the present invention, if the second user has electronic health records, then an ML based data capturing technique (e.g., Amazon Comprehend Medical®, and Amazon Comprehend®) is implemented by the data capturing unit 114 for extracting health data and Personal Identifiable Information (PII) (e.g., mobile number, occupation, and mailing address) of the second user over the audio and video communication. The extracted health data is used to automatically fill the health data sections associated with the second user on the first user-end of the GUI. In another embodiment of the present invention, the first user visualizes, via the GUI, a transcript of the call below a ‘call area’ present on the GUI while communicating with the second user.

In an embodiment of the present invention, as described above, the integration unit 116 is configured to integrate with and invoke one or more external data sources (e.g., CRM data source) for extracting product and service specific data associated with the second user from the external data sources based on the captured second user data. The product and service specific data is extracted by implementing the Application Programming Interface (API), which integrates the integration unit 116 with the external data sources. The extracted data is provided to the data capturing unit 114. In an example, if the second user is availing insurance services, then the API extracts clinical and medical data associated with the second user, which is an electronic protected health information (ePHI), from the external data sources. The ePHI is further sent to the data capturing unit 114 for capturing the second user's health data such as, height, weight, Body Mass Index (BMI), and health issues. The clinical and medical data associated with the second user is extracted from the external data sources in a standard compliance manner (e.g., Health Insurance Portability and Accountability Act (HIPAA) compliant manner). In an embodiment of the present invention, the captured and extracted second user data is stored in the database 124 for later retrieval. In an exemplary embodiment of the present invention, the database 124 is an Amazon DynamoDB®. The stored data is encrypted using encryption keys associated with a key management service (e.g., AWS Key Management Service® (AWS KMS)).

In an embodiment of the present invention, the recommendation unit 118 is configured to provide real-time recommendations to the first user with respect to the product and service specific data associated with the second user. The recommendations relate to suitable product and service references associated with the second user. The recommendation unit 118 is configured with built-in analytics for providing product and service recommendations associated with the user. The built-in analytics implements one or more conversational AI bots for providing suitable recommendations to the first user with respect to products and services associated with the second user. In an embodiment of the present invention, the recommendation unit 118 is configured to provide one or more types of recommendations by implementing one or more types of conversational AI bots. In an embodiment of the present invention, a first type of recommendation provided by a first conversational AI bot relates to generating and recommending a risk profile of the second user. In an embodiment of the present invention, a second type of recommendation provided by a second conversational AI bot relates to providing recommendations based on the queries provided by the first user. For example, the second conversational AI bot may ingest product related queries from the first user (e.g., an insurance agent) and renders answers to the product related queries, explains product features, inclusions, and associated riders. In an embodiment of the present invention, a third type of recommendation provided by a third conversational AI bot relates to providing answers to queries related to the organization's brochures and product recommendation with respect to the product and service associated with the second user. The third conversational AI bot extracts necessary information with respect to the selected products and services and provides a summarized response. The third conversational AI bot processes data associated with the selected products and services, determines its pros and cons, and provides a conclusion and the summary that aligns to the first user query. Advantageously, the implementation of conversational AI bots provides an engaging and contextual communication between the first user and the second user. Further, in an embodiment of the present invention, the first user selects one or more words which are displayed in a transcript associated with the call below a ‘call area’ present on the GUI while communicating with the second user by converting the second user's speech to text format. The selection of words aids in providing accurate recommendations.

In an embodiment of the present invention, the finalization unit 120 is configured to provide a finalization option to the second user for selecting one or more parameters with respect to the product and service specific data with respect to user's needs and requirements. For example, prior to the finalizing insurance policy, the second user may select a parameter relating to beneficiary type such as choosing between individual or trust as beneficiary type and add beneficiary details along with an allocation percentage. Further, the selected parameters may be visualized and updated on the GUI by the second user. For example, the second user may view, and update beneficiary details of all existing policies associated with the insurer (i.e., the first user). In an embodiment of the present invention, the finalization unit 120 authenticates the identity of the second user and verifies identity of the second user for preventing any fraudulent activity. In an example, the second user may provide residence data with respect to last two years and data with respect to usage of controlled substances for the last 10 years for identity verification.

In an embodiment of the present invention, the finalization unit 120 enables e-signing of documents by the second user related to availed product and services and making payment using e-payment service for the availed product and services. In an exemplary embodiment of the present invention, the finalization unit 120 invokes DocuSign® API for the e-sign and Stripe® payment gateway API is invoked for e-payment, respectively.

In an embodiment of the present invention, the review unit 122 is configured to generate an actionable outcome for transmission to the input device 110 of the digital communication via the input device 110 for review. For example, if the product and services relate to insurance policy, then the outcome of the digital communication relates to submitting the insurance policy for underwriting. Advantageously, an improved customer experience is seamlessly provided, with great efficiency for the first user, and improved data quality to carry out the underwriting process. In an embodiment of the present invention, the LLM unit 126 transcribes entire audio and video communication between the first and the second user and generates a transcript summary including one or more essential action items. The summary is mailed to the second user using an AWS Simple Email Service® (SES) technique.

In an embodiment of the present invention, the security and monitoring unit 128 is configured to maintain and monitor security of the digital communication between the first user and the second user. In an exemplary embodiment of the present invention, the security and monitoring unit 128 implements AWS CloudTrail® tool for enabling operational and risk auditing, governance, and compliance. Further, the security and monitoring unit 128 implements Amazon CloudWatch® tool to collect and track metrics, collect and monitor log files, and set alarms to improve operational functionalities.

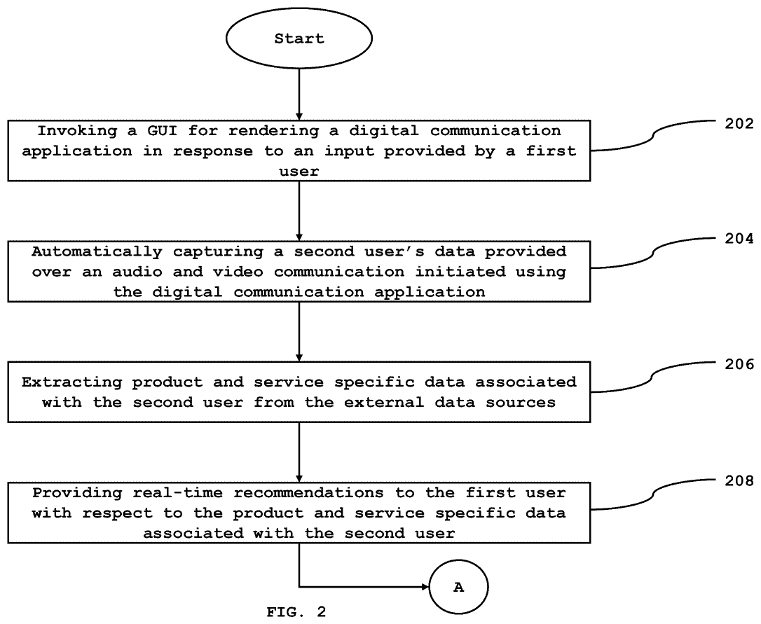

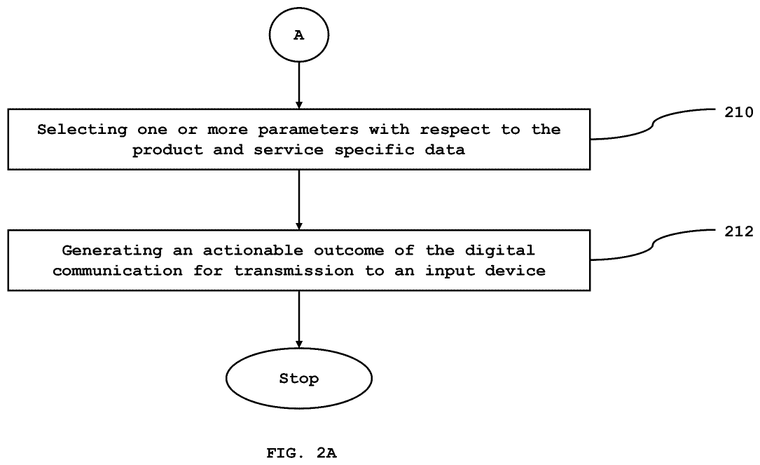

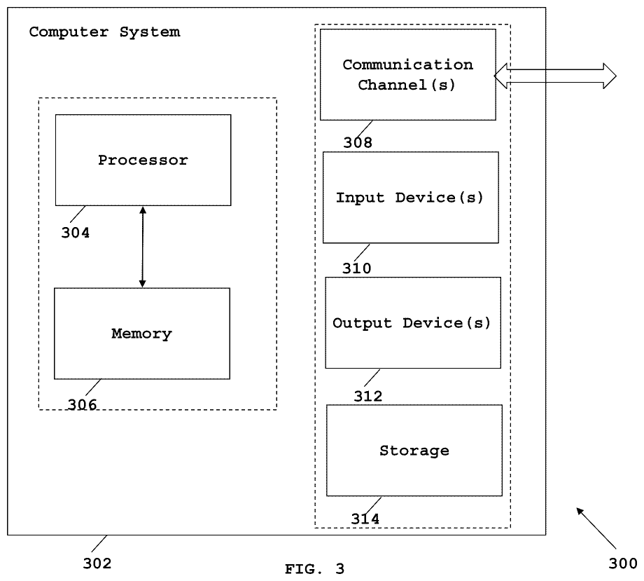

FIG. 2 and FIG. 2A illustrate a flowchart depicting a method for rapid end-to-end digital communication between users, in accordance with an embodiment of the present invention.

At step 202, a Graphical User Interface (GUI) is invoked for rendering a digital communication application in response to an input provided by a first user. In an embodiment of the present invention, the subsystem (102) is integrated with a relationship management tool (not shown) (e.g., Salesforce Customer Relationship Management (CRM) tool), for receiving data relating to one or more second user requirements associated with a service provided by an organization relating to a particular domain. The received data may be accessed by a first user. The first user is a representative or employee of an organization relating to a particular domain. For example, the first user may be an insurance agent in an insurance company. In an embodiment of the present invention, a GUI invoked for rendering the digital communication application in response to an input provided by a first user over the GUI. In an embodiment of the present invention, the digital communication application is developed in a codeless manner by using a no-code development platform-as-a-service (e.g., Unqork®) and provides audio and video features for communication along with other features for communication.

In an exemplary embodiment of the present invention, the digital communication application is developed using a ‘React Framework’ which is used to build audio-video component by using an Amazon Web Services (AWS) Chime® Software Development Kit (SDK) and the audio-video component is embedded in the no-code development platform-as-a-service. In an embodiment of the present invention, AWS Chime SDK associated with AWS Chime API is developed for rendering the digital communication application. The first user selects a Universal Resource Locator (URL) link and inserts login credentials for invoking the GUI for connecting to the digital communication application and provides the inputs. In an exemplary embodiment of the present invention, the URL is a public-facing URL. The input is in the form of a request which represents the first user's requirement for rendering the digital communication application for communicating with a second user. The second user represents one or more users whose requirement data was received. The first user is a representative of an organization in a particular domain. For example, the first user may be an insurance agent in an insurance company. The selection of URL renders audio and video chat features on the GUI for allowing the first user to communicate with the second user. The second user is an individual or a customer availing one or more services of the organization in which the first user is employed. For example, the second user may require an insurance policy from the first user. In an embodiment of the present invention, a personalised communication (e.g., an email) invite is generated and sent to the second user, prior to the digital communication, relating to the product and service information for the product and service availed by the second user. The personalized communication is generated by the LLM unit 126 based on queries constructed from the data related to the second user requirements (e.g., name, age, product, and service details, etc.) which are provided to LLM models as input for generating the personalized communication. The second user may view the communication invite via an electronic device (e.g., a smartphone, a laptop, a computer, a tablet, etc.) at his/her end.

In an embodiment of the present invention, a pre-determined Domain Name System (DNS) service (e.g., Amazon Route 53®) is implemented to route the first user input to a content delivery service platform (e.g., Amazon CloudFront®) for rendering the digital communication application. The first user input is routed to the content delivery service platform by using an Application Programing Interface (API) gateway (e.g., Amazon API Gateway®). The Application Programing Interface (API) gateway creates and deploys APIs that access the digital communication application implemented using a serverless platform (e.g., Amazon Web Services® (AWS)). The digital communication application is containerized and managed in an application management platform (e.g., Amazon Elastic Kubernetes Service® (Amazon EKS) cluster). One or more audio and video features associated with the digital communication application are built using a Software Development Kit (SDK) (e.g., Amazon Chime SDK®, React, etc.). The audio and video features associated with the digital communication application allow the second user to view the first user and talk to the first user. The digital communication application is deployed in a pre-defined object storage location (e.g., Amazon Simple Storage Service® (Amazon S3) and CloudFront®). In an exemplary embodiment of the present invention, a private connectivity protocol (e.g., AWS Private Link®) is used to keep the network traffic between one or more Virtual Private Clouds (VPCs) associated with the digital communication application development platform and the second user within an AWS network, without using public internet protocols (IPs) and without requiring traffic to traverse across the internet.

In an embodiment of the present invention, the digital communication application is fetched from the object storage location when the URL is selected by the first user. The first user communicates and interacts with the second user using the digital communication application. In an embodiment of the present invention, a dialogue script is generated and provided by using previously generated risk profile as inputs in the form of prompt to the LLM unit 126. The dialogue script is used by the first user for providing product and services recommendations and chat inputs to the second user regarding the product and services. In another embodiment of the present invention, the audio and video communication between the first user and the second user transcribed, which is used to determine sentiments (e.g., happy, sad, angry, inquisitive, confused, etc.) of the second user at a particular point in time. The sentiments of the second user are determined based on one or more phrases provided by the second user during the audio and video communication. In an exemplary embodiment of the present invention, the sentiments are expressed via the GUI by using one or more emojis, which are visible to the first user.

At step 204, the second user's data is automatically captured, which is provided over an audio and video communication initiated using the digital communication application. In an embodiment of the present invention, the second user's data provided over the audio and video communication is automatically captured in one or more digital formats associated with the product and service availed by the second user. The second user data may include, but is not limited to, second user personal data (e.g., name, mailing address, email, occupation, mobile number, height, weight, BMI, and social security number, etc.), service details, product details, etc. Pre-trained artificial intelligence (AI) techniques (e.g., AWS® transcribe and AWS® comprehend) are implemented for automatically capturing the second user data.

In an embodiment of the present invention, the audio and video communication between the first user and the second user is recorded. In an exemplary embodiment of the present invention, the audio and video communication recordings are stored in a storage location such as Amazon S3® buckets and the stored communication recordings are secured using an S3 server-side encryption. In an embodiment of the present invention, an Automated Speech Recognition (ASR) technique (e.g., Amazon Transcribe®) is implemented for converting the captured audio and video communications, which are in speech format, into a text format. In an exemplary embodiment of the present invention, if the second user has electronic health records, then an ML based data capturing technique (e.g., Amazon Comprehend Medical®, and Amazon Comprehend®) is implemented for extracting health data and Personal Identifiable Information (PII) (e.g., mobile number, occupation, and mailing address) of the second user over the audio and video communication. The extracted health data is used to automatically fill the health data sections associated with the second user on the first user end of the GUI. In another embodiment of the present invention, the first user visualizes, via the GUI, a transcript of the call below a ‘call area’ present on the GUI while communicating with the second user.

At step 206, product and service specific data associated with the second user is extracted from the external data sources. In an embodiment of the present invention, one or more external data sources (e.g., CRM data source) are invoked for extracting product and service specific data associated with the second user from the external data sources based on the captured second user data. The product and service specific data is extracted by implementing the Application Programming Interface (API), which integrates with the external data sources. In an example, if the second user is availing insurance services, then the API extracts clinical and medical data associated with the second user, which is an electronic protected health information (ePHI), from the external data sources. The ePHI is further processed for capturing the second user's health data such as, height, weight, Body Mass Index (BMI), and health issues. The clinical and medical data associated with the second user is extracted from the external data sources in a standard compliance manner (e.g., Health Insurance Portability and Accountability Act (HIPAA) compliant manner). In an embodiment of the present invention, the captured and extracted second user data is stored in the database for later retrieval.

At step 208, real-time recommendations are provided to the first user with respect to the product and service specific data associated with the second user. In an embodiment of the present invention, the recommendations relate to suitable product and service references associated with the second user. One or more conversational AI bots are implemented for providing suitable recommendations to the first user with respect to products and services associated with the second user. In an embodiment of the present invention, one or more types of recommendations are provided by implementing one or more types of conversational AI bots. In an embodiment of the present invention, a first type of recommendation provided by a first conversational AI bot relates to generating and recommending a risk profile of the second user. In an embodiment of the present invention, a second type of recommendation provided by a second conversational AI bot relates to providing recommendation based on the queries provided by the first user. For example, the second conversational AI bot may ingest product related queries from the first user (e.g., an insurance agent) and renders answers to the product related queries, explains product features, inclusions, and associated riders. In an embodiment of the present invention, a third type of recommendation provided by a third conversational AI bot relates to providing answers to queries related to the organization's brochures and product recommendation with respect to the product and service availed by the second user. The third conversational AI bot extracts necessary information with respect to the selected products and services and provides a summarized response. The third conversational AI bot processes data associated with the selected products and services, determines its pros and cons, and provides a conclusion and the summary that aligns to the first user query. Further, in an embodiment of the present invention, the first user selects one or more words which are displayed in a transcript associated with the call below a ‘call area’ present on the GUI while communicating with the second user by converting the second user's speech to text format.

At step 210, one or more parameters with respect to the product and service specific data are selected. In an embodiment of the present invention, a finalization option is provided to the second user for selecting one or more parameters with respect to the product and service specific data with respect to user's needs and requirements. For example, prior to the finalizing insurance policy, the second user may select a parameter relating to beneficiary type such as, choosing between individual or trust as beneficiary type and add beneficiary details along with an allocation percentage. Further, the selected parameters may be visualized and updated on the GUI by the second user. For example, the second user may view, and update beneficiary details of all existing policies associated with the insurer (i.e., the first user). In an embodiment of the present invention, analytics techniques (e.g., LexisNexis Risk Solutions®, etc.) are executed for determining identity of the second user, authenticating identity of the second user, and verifying identity of the second user for preventing any fraudulent activity. In an example, the second user may provide residence data with respect to last two years and data with respect to usage of controlled substances for the last 10 years for identity verification.

In an embodiment of the present invention, e-signing of documents is carried out by the second user related to availed product and services and making payment using e-payment service for the availed product and services. In an exemplary embodiment of the present invention, DocuSign® API is invoked for the e-sign and Stripe® payment gateway API is invoked for e-payment, respectively.

At step 212, an actionable outcome of the digital communication is generated for transmission to an input device. In an embodiment of the present invention, the outcome of the digital communication is reviewed. For example, if the product and services relate to insurance policy, then the outcome of the digital communication relates to submitting the insurance policy for underwriting. In an embodiment of the present invention, entire audio and video communication between the first and the second user is transcribed, and a transcript summary is generated including one or more essential action items. The summary is mailed to the second user using an AWS Simple Email Service® (SES) technique.

Advantageously, in accordance with various embodiments of the present invention, the present invention provides optimized digital communication between users by using a codeless and serverless architecture for rendering the digital communication application. The serverless architecture frees users from undifferentiated heavy lifting in infrastructure management such as server provisioning and maintenance. Further, the present invention provides dynamic digital communication between users. Also, the present invention provides highly automated and seamless digital communication between users by reducing the development, management and maintenance efforts associated with the digital communication platform. Yet further, the present invention provides interactive digital communication between users thereby improving user experience.

FIG. 3 illustrates an exemplary computer system 302 in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302 and manages different functionalities of the components of the computer system 302.

The communication channel(s) 308 allows communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth, or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including, but not limited to microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for rapid end-to-end digital communication between users, the system comprises:
a memory storing program instructions;
a processor executing program instructions stored in the memory; and
a digital communication engine executed by the processor and configured to:
receive an input by a first user for invoking a Graphical User Interface (GUI) on an input device for rendering a digital communication application subsequent to receiving data related to one or more second user requirements associated with a service;
capture a second user data provided over audio and video communication carried out between the first user and the second using audio and video features associated with the digital communication application, wherein the second user data is captured in one or more digital formats;
extract product and service specific data associated with the second user based on the captured second user data from an external data source;
provide one or more types of recommendations to the first user with respect to the product and service specific data associated with the second user by implementing one or more types of conversational AI bots;
select one or more parameters associated with the product and service specific data; and
generate an actionable outcome of the digital communication for transmission to the input device.

2. The system as claimed in claim 1, wherein the digital communication engine comprises an integration unit executed by the processor and configured to integrate with a relationship management tool for receiving the data related to second user requirements associated with the service corresponding to a particular domain.

3. The system as claimed in claim 1, wherein the digital communication application is developed in a no-code or low-code manner by using a no-code or low code development platform-as-a-service and provides audio and video features for communication.

4. The system as claimed in claim 1, wherein the system comprises a Large Language Model (LLM) unit configured to generate a personalised communication invite for the second user based on queries constructed from the data related to the second user requirements which are provided to LLM models in the LLM unit as input prior to the invocation of the GUI.

5. The system as claimed in claim 1, wherein a pre-determined Domain Name System (DNS) service is implemented by a GUI rendering unit to route the first user input to a content delivery service platform for rendering the digital communication application on an input device.

6. The system as claimed in claim 1, wherein the system comprises a Large Language Model (LLM) unit configured to generates a dialogue script by using previously generated risk profile of the second user, and wherein the dialogue script is used by the first user for providing product and services recommendations and chat inputs to the second user.

7. The system as claimed in claim 6, wherein the LLM unit transcribes the audio and video communication between the first user and the second user which is used to determine sentiments of the second user, and wherein the sentiments of the second user are determined by the LLM unit based on one or more phrases provided by the second user during the audio and video communication.

8. The system as claimed in claim 1, wherein the digital communication engine comprises a data capturing unit executed by the processor and configured to automatically capture the second user data from a GUI rendering unit in text format.

9. The system as claimed in claim 8, wherein the data capturing unit records the audio and video communication between the first user and the second user, and wherein the data capturing unit implements an Automated Speech Recognition (ASR) technique for converting the captured audio and video communication into a text format.

10. The system as claimed in claim 9, wherein the digital communication engine comprises an integration unit 116 executed by the processor and configured to integrate with the one or more external data sources for extracting product and service specific data.

11. The system as claimed in claim 1, wherein the digital communication engine comprises a recommendation unit executed by the processor and configured to provide real-time recommendations to the first user with respect to the product and service specific data associated with the second user, and wherein a first type of recommendation provided by a first conversational AI bot includes generating and recommending a risk profile of the second user; a second type of recommendation provided by a second conversational AI bot includes providing recommendation based on the queries provided by the first user; and a third type of recommendation provided by a third conversational AI bot includes providing answers to queries related to the organization's brochures and product recommendation with respect to the product and service associated with the second user.

12. The system as claimed in claim 1, wherein the digital communication engine comprises a finalization unit executed by the processor and configured to provide a finalization option to the second user for selecting the one or more parameters with respect to the product and service specific data, and wherein the finalization unit authenticates identity of the second user for preventing fraudulent activity.

13. A method for rapid end-to-end digital communication between users, the method is implemented by a processor executing instructions stored in a memory, the method comprises:
receiving an input by a first user for invoking a Graphical User Interface (GUI) on an input device for rendering a digital communication application subsequent to receiving data related to one or more second user requirements associated with a service;
capturing a second user data provided over audio and video communication carried out between the first user and the second user using audio and video features associated with the digital communication application, wherein the second user data is captured in one or more digital formats;
extracting product and service specific data associated with the second user based on the captured second user data from an external data source;
providing one or more types of recommendations to the first user with respect to the product and service specific data associated with the second user by implementing one or more types of conversational AI bots;
selecting one or more parameters associated with the product and service specific data; and
generating an actionable outcome of the digital communication for transmission to the input device.

14. The method as claimed in claim 13, wherein a personalised communication invite is generated for the second user based on queries constructed from the data related to the second user requirements which are provided to LLM models in the LLM unit as input prior to the invocation of the GUI.

15. The method as claimed in claim 13, wherein a dialogue script is generated by using previously generated risk profile of the second user, and wherein the dialogue script is used by the first user for providing product and services recommendations and chat inputs to the second user.

16. The method as claimed in claim 15, wherein the audio and video communication are transcribed between the first user and the second user which is used to determine sentiments of the second user, and wherein the sentiments of the second user are determined based on one or more phrases provided by the second user during the audio and video communication.

17. The method as claimed in claim 13, wherein real-time recommendations are provided to the first user with respect to the product and service specific data associated with the second user, and wherein a first type of recommendation provided by a first conversational AI bot includes generating and recommending a risk profile of the second user; a second type of recommendation provided by a second conversational AI bot includes providing recommendation based on the queries provided by the first user; and a third type of recommendation provided by a third conversational AI bot includes providing answers to queries related to the organization's brochures and product recommendation with respect to the product and service associated with the second user.

18. The method as claimed in claim 13, wherein a finalization option is provided to the second user for selecting the one or more parameters with respect to the product and service specific data, and wherein identity of the second user is authenticated for preventing fraudulent activity.

19. A computer program product comprising:
a non-transitory computer-readable medium having computer program code stored thereon, the computer-readable program code comprising instructions that, when executed by a processor, causes the processor to:
receive an input by a first user for invoking a Graphical User Interface (GUI) on an input device for rendering a digital communication application subsequent to receiving data related to one or more second user requirements associated with a service;
capture a second user data provided over audio and video communication carried out between the first user and the second user using audio and video features associated with the digital communication application, wherein the second user data is captured in one or more digital formats;
extract product and service specific data associated with the second user based on the captured second user data from an external data source;
provide one or more types of recommendations to the first user with respect to the product and service specific data associated with the second user by implementing one or more types of conversational AI bots;
select one or more parameters associated with the product and service specific data; and
generate an actionable outcome of the digital communication for transmission to the input device.
